(19) United States
(12) Patent Application Publication
(10) Pub. No.: US 2003/0180588 A1
(43) Pub. Date: Sep. 25, 2003

(54) High-temperature fuel cell power station having reduced carbon dioxide emissions

(76) Inventor: Frank Thom, Duren (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/344,613

(22) PCT Filed: Jul. 21, 2001
(86) PCT No.: PCT/DE01/02831

(30) Foreign Application Priority Data
Aug. 23, 2000 (DE) 10041262.9

(51) Int. Cl. H01M 8/06; H01M 8/04; C01B 3/24

(52) U.S. Cl. 429/20; 429/26; 423/650

(57) ABSTRACT

Fuel cell power stations have established themselves as methods for producing electricity, heat and hydrogen from fossil fuels. Up to now, the resulting CO₂ can be liquefied and subsequently stored or deposited in beds only by using complicated techniques. According to the inventive method, the majority of the carbon, which is located inside the fuel that contains hydrocarbons, is converted into solid carbon before the actual electrochemical reaction inside the fuel cell. The solid carbon can then be easily passed out of the system and no longer presents any threat to the environment. The resulting carbon constitutes a valuable product, which can be utilized for other process steps or sold.

### TECHNICAL FIELD

The invention relates to a high-temperature fuel-cell power plant as well as to a method for the improved utilization of such a power plant.

### STATE OF THE ART

In a high-temperature fuel-cell power plant, apart from the MCFC (molten carbonate fuel cell) the SOFC (solid oxide fuel cell) is used for electric current generation and hydrogen production (H. E. Vollmer, C. Ü. Maier, C. Nölscher, T. Merklein, M. Poppinger; Innovative concepts for the coproduction of electricity and syngas with solid oxide fuel cells, Journal of Power Sources, Vol. 86, (2000), pp. 90-97). As the fuel, natural gas is used. Typically within or externally of the fuel cell there is a reformation of the methane with water vapor to CO and hydrogen. These react then in the anode electrochemically to water and CO₂. The resulting gaseous CO₂ gives rise however as a rule to environmental emissions, since CO₂ is counted as a greenhouse gas. A reduction of the CO₂ from a gaseous atmosphere can only be realized with difficulty.

Advances in the process of lique faction have already provided appropriate devices to separate CO₂ and liquify it to enable it to be stored separately (E. Riensche, E. Achenbach, D. Froning, M. R. Heines, W. K. Heidug, A. Lokurlu, S. von Andrian; Clean combined-cycle SOFC power plant—cell modeling and process analysis; Journal of Power Sources, vol. 86, (2000), pp. 404-410).

So called emission-free fuel-cell power plants pump the produced and then liquefied CO₂ into empty subterranium petroleum or natural gas storage locations. There it is intended to be retained permanently.

### OBJECT AND SOLUTION

The object of the invention is to provide a method of electric current/hydrogen generation in which a liquefied or gaseous CO₂ production is substantially completely avoided.

The object is achieved with a method of operating a high temperature fuel cell power plant according to the main claim. Advantageous methods of operation are given in the claim dependent thereon.

### DESCRIPTION OF THE INVENTION

The method according to the invention of claim 1 for operating a high-temperature fuel-cell power plant is characterized in that a hydrocarbon containing fuel is converted to solid carbon.

In a fuel-cell power plant, through an electrochemical conversion of a fuel and an oxidizing medium with the aid of a high temperature fuel cell, for example, the SOFC, electric current is produced. Typical hydrocarbon containing fuels are thus natural gas with its principal component methane or also methanol. A conversion of a hydrocarbon containing fuel is effected for example by endothermic decomposition [cracking] reactions according to:

CH₄⇄C+2H₂

C₂H₆⇄2C+3H₂

By appropriate choice of the reaction parameters, like for example, the temperature, the pressure or the concentration of the individual reaction partners, the reaction equilibrium can be shifted to one side so that the decomposition can be approximately complete.

These decomposition reactions have as a precondition the absence of oxygen since otherwise during these reactions detrimental carbon oxides can be formed.

The method according to the invention has the advantage that, from the hydrocarbon containing fuel the carbon deposits as solid carbon (graphite, carbon black) which can be removed in a simple manner from the system and so that it does not occur as environmentally detrimental CO or CO₂. The solid carbon can for example solely based upon the density difference be removed by gravitational effect or also to an increased extent by filters from the gaseous hydrogen which is formed and can be discharged from the system.

In one advantageous embodiment, the carbon is converted to solid carbon from the fuel gas in an amount in excess of 50% and especially in an amount in excess of 90%. Thus the method of operating a fuel cell power plant in this case is approximately CO₂ emission free.

Especially suitable fuels are gaseous hydrocarbon, especially those hydrocarbon which are in a gaseous state at room temperature (25° C.) and standard pressure (1 bar), for example methane, since here the conversion to solid carbon through the decomposition reaction can be effected without prior conversion of the hydrocarbon to the gas phase. Furthermore, the reaction parameters (for example the equilibrium constant) for this reaction are highly desirable.

In one embodiment of the invention the decomposition reaction of the hydrocarbon fuel is effected prior to the conversion in the fuel cell itself. As a result the carbon is separated off upstream of the fuel cell and predominantly only hydrogen is fed to the fuel cell.

A further advantage is obtained from the use of the heat generated by the electrochemical transformation reaction in the high-temperature fuel cell for the mostly endothermic decomposition of the hydrocarbon-containing fuel. The heat produced by the fuel cell can be supplied convectively, for example, in a waste gas flow, or also by direct thermal radiation or thermal conduction, to the location of the decomposition reaction. Then, for example, the apparatus for transforming the fuel into solid carbon can be in direct contact with the fuel cell stack. The heat produced in the usual mode of operation of a high-temperature fuel-cell power plant is typically continuous and produced in a permanent manner so that the apparatus for cracking the hydrocarbon can advantageously be continuously operated.

When the heat removal from the fuel cell, for example, is by utilizing the radiated heat in the decomposition apparatus, it is possible to cool the fuel cell in a targeted manner through the endothermic decomposition reaction. A reduction in the amount of oxygen to the stoichiometric requirement is thus possible.

In an advantageous arrangement in accordance with the invention, the quantity of the hydrocarbon containing fuel gas, especially the methane, is so controlled that in the fuel decomposer substantially more hydrogen is produced than is electrochemically converted in the high temperature fuel cell stack. Thus it is possible to produce hydrogen and at the same time effectively to cool the fuel cell. Then a part of the hydrogen flow can be withdrawn from the apparatus. Fuel gas, for example natural gas, is then decomposed in excess. An excess feed in the sense of the invention is especially advantageous when the amount of hydrogen drawn off is at least 20%, advantageously at least 50%, of the hydrogen produced during the decomposition.

### DESCRIPTION OF THE DRAWING

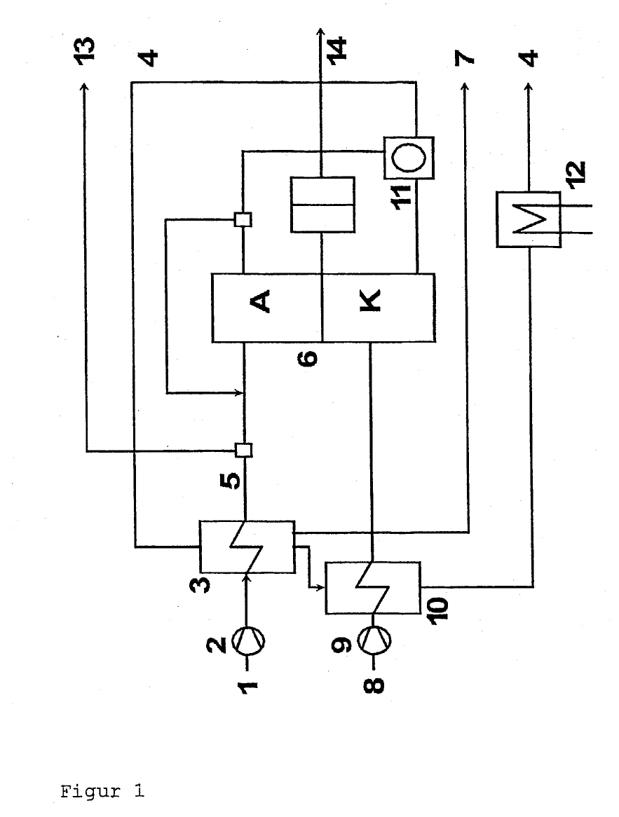

In the following, the method is described in conjunction with a simplified process flow diagram (FIG. 1) of a solid oxide high temperature fuel cell apparatus. Natural gas 1 is fed after compression 2 into a methane decomposer 3. The heat required to drive the endothermic reaction 2 [sic] is convectively transferred by an exhaust gas stream 4. The hydrogen 5 which is discharged from the methane decomposer is advantageously at the working temperature of the stack 6 (700-1000° C.). In addition, the methane decomposer 3 is structurally so formed that the hydrogen has negligibly small quantities of carbon black particles. The solid carbon which is produced is withdrawn from the methane decomposer 3 by a suitable conveyor unit 7. Air 8 is compressed in a compressor 9 and is preheated in an air preheated 10 also to the working temperature of the stack. In the fuel cell stack [6] an electrochemical conversion of hydrogen and oxygen to water vapor is carried out. Electric current is generated at 14. The anodecide and cathocide waste gases are burned in an after burner chamber 11. The exhaust gas stream has its heat drawn off in the decomposition apparatus 3 and the air preheater 10. The remaining quantity of heat can also be used by being withdrawn as additional heat in a useful heat exchanger 12. Finally a waste gas 4 leaves the apparatus and is substantially CO₂ free. A CO₂ free exhaust gas in the sense of the invention is one in which the ratio of the CO₂ molar flow to the natural gas molar flow at the inlet (here taken as 100% methane) is less than 2%.

### EXAMPLES

In one example of the method of the invention the electrochemical H₂ transformation (reaction 1) is combined with the methane decomposition reaction (reaction 2). Reaction 1 is exothermic and is carried out in the high temperature fuel cell, reaction 2 by contrast being endothermic and carried out with heat supplied in a heat resistant apparatus.

H₂÷0.5O₂⇄H₂O ΔH_{1000K}=−248 kJ/mol Reaction 1

CH₄⇄C+2 H₂ ΔH_{1000K}=90 kJ/mol Reaction 2

The equilibrium decision of the reaction 2 can be described by the following temperature dependant equilibrium constant Kₚ (Ullmann, 4th edition, 1977, volume 14, Gas generation from coal and hydrocarbons):

| With temperature/° C. | ${K}_{c} = {K}_{p} / [ bar ] = \frac{{p}^{2} ( {H}_{2} )}{p ( {CH}_{4} )}$ |
|---|---|
| 700 | 7.8 |
| 800 | 22.0 |
| 900 | 52.7 |
| 1000 | 100 |

Fuel cell power plants have established themselves as processes for producing electric current and hydrogen. The CO₂ which is thereby produced has for some time only been liquefied by expensive technology and then stored or deposited in disposal sites. The method according to the invention opens by contrast a path of the technology of fuel cell power plants to be utilized more effectively and the problem of CO₂ emissions to be reduced in a simple way by the conversion clearly to solid carbon. The carbon produced can be utilized in a targeted manner for subsequent synthesis or processes or can be sold.

Reference characters to FIG. 1.

| Number | Significance |
|---|---|
| 1 | Natural gas |
| 2 | Compressor |
| 3 | Methane decomposer |
| 4 | Exhaust gasline |
| 5 | Hydrogen line |
| 6 | SOFC fuel cell stack |
| 7 | Carbon conveyor unit |
| 8 | Air |
| 9 | Compressor |
| 10 | Air preheater |
| 11 | Afterburner chamber |
| 12 | Useful heat exchanger |
| 13 | Hydrogen line |
| 14 | Electric current |

1. A method of operating a high temperature fuel cell power plant, characterized in that the heat produced in a fuel cell is at least partly supplied to a continuously operating methane decomposition reaction in which the methane is at least partly transformed into solid carbon.

2. The method according to the preceding claim 1 in which the heat transfer is effected by thermo radiation.

3. The method according to claim 1 in which the methane decomposition is carried out upstream of the fuel cell.

4. The method according to claim 1 in which a maximum of 80%, especially not more than 50%, of the hydrogen produced by methane decomposition is transformed in the fuel cell.

5. An apparatus for carrying out the method according to claim 1, comprising a fuel cell, a device for methane decomposition, means for feeding hydrogen to the fuel cell, means for carrying away solid carbon, as well as means for the transmission of the heat produced in the fuel cell to the device for methane decomposition.
